(19) United States
(12) Patent Application Publication
(10) Pub. No.: US 2019/0390924 A1
(43) Pub. Date: Dec. 26, 2019

(54) APPARATUS FOR CONDITIONING HEAT EXCHANGER FLOW

(71) Applicant: United Technologies Corporation, Farmington, CT (US)

(72) Inventors: Corey D. Anderson, East Hartford, CT (US); Lauryn M. Curtis, Manchester, CT (US)

(21) Appl. No.: 16/014,186

(22) Filed: Jun. 21, 2018

(51) Int. Cl. F28F 13/12

(52) U.S. Cl. CPC F28F 13/12; F02C 7/00

(57) ABSTRACT

A heat exchanger for a gas turbine engine including: a heat exchanger core having an inlet, an outlet, and a fluid passageway; an inlet pipe configured to provide hot airflow to the inlet; and an inlet flow conditioner fluidly connecting the outlet of the inlet pipe to the inlet of the heat exchanger core, the inlet flow conditioner including: a central attachment body; an outer shell located radially outward from the central attachment body, the outer shell including an inlet connected to the outlet of the inlet pipe, and an outlet opposite the inlet and connected to the inlet of the heat exchanger core; and a plurality of guide vanes extending from the central attachment body to the outer shell, the plurality of guide vanes being configured to impart a swirl upon airflow entering the inlet of the inlet flow conditioner and exiting the outlet of the inlet flow conditioner.

### BACKGROUND

The subject matter disclosed herein generally relates to gas turbine engines and, more particularly, to a method and apparatus for conditioning airflow to heat exchangers of gas turbine engines.

Heat exchangers built for aircraft must be compact yet provide enough heat transfer surface area for adequate heat transfer. Failure to maximize use of the heat transfer surface area may lead to reduced effectiveness of the heat exchanger.

### SUMMARY

According to an embodiment, a heat exchanger for a gas turbine engine is provided. The heat exchanger including: a heat exchanger core having an inlet, an outlet, and a fluid passageway fluidly connecting the inlet to the outlet, the fluid passageway is in thermal communication with a second passageway with a cooling fluid; an inlet pipe having an outlet fluidly connected to the inlet of the heat exchanger core, the inlet pipe configured to provide hot airflow to the inlet of the heat exchanger core, the outlet of the inlet pipe having a cross-sectional area less than a cross-sectional area of the inlet of the heat exchanger core; and an inlet flow conditioner fluidly connecting the outlet of the inlet pipe to the inlet of the heat exchanger core, the inlet flow conditioner including: a central attachment body; an outer shell located radially outward from the central attachment body, the outer shell including an inlet connected to the outlet of the inlet pipe, and an outlet opposite the inlet and connected to the inlet of the heat exchanger core; and a plurality of guide vanes extending from the central attachment body to the outer shell, the plurality of guide vanes being configured to impart a swirl upon airflow entering the inlet of the inlet flow conditioner and exiting the outlet of the inlet flow conditioner.

In addition to one or more of the features described herein, or as an alternative, further embodiments may include an inlet manifold fluidly connecting the inlet flow conditioner to the heat exchanger core, the inlet manifold including an inlet connected to the outlet of the inlet flow conditioner and an outlet connected to the inlet of the heat exchanger core.

In addition to one or more of the features described herein, or as an alternative, further embodiments may include that the outlet of the inlet manifold has a cross-sectional area larger than a cross-sectional area of the inlet of the inlet manifold.

In addition to one or more of the features described herein, or as an alternative, further embodiments may include that the cross-sectional area of the outlet of the inlet manifold is about equal to the cross-sectional area of the inlet of the heat exchanger core.

In addition to one or more of the features described herein, or as an alternative, further embodiments may include that the outlet of the inlet flow conditioner has a cross-sectional area larger than a cross-sectional area of the inlet of the inlet flow conditioner.

In addition to one or more of the features described herein, or as an alternative, further embodiments may include that the cross-sectional area of the outlet of the inlet flow conditioner is about equal to the cross-sectional area of the inlet of the inlet manifold.

In addition to one or more of the features described herein, or as an alternative, further embodiments may include that the cross-sectional area of the inlet of the inlet flow conditioner is about equal to the cross-sectional area of the outlet of the inlet pipe.

In addition to one or more of the features described herein, or as an alternative, further embodiments may include that the central attachment body further includes a nose cone proximate the inlet of the inlet flow conditioner, the nose cone being configured to direct hot airflow entering the inlet of the inlet flow conditioner around the central attachment body.

In addition to one or more of the features described herein, or as an alternative, further embodiments may include that the central attachment body further includes a tail cone proximate the outlet of the inlet flow conditioner, the tail cone being configured to direct hot airflow exiting the outlet of the inlet flow conditioner around the central attachment body.

In addition to one or more of the features described herein, or as an alternative, further embodiments may include that the central attachment body further includes a tail cone proximate the outlet of the inlet flow conditioner, the tail cone being configured to direct hot airflow exiting the outlet of the inlet flow conditioner around the central attachment body.

In addition to one or more of the features described herein, or as an alternative, further embodiments may include that the outer shell is conical frustum in shape.

In addition to one or more of the features described herein, or as an alternative, further embodiments may include that the outer shell is contoured in shape.

In addition to one or more of the features described herein, or as an alternative, further embodiments may include that the outlet of the inlet flow conditioner has a cross-sectional area larger than a cross-sectional area of the inlet flow conditioner.

In addition to one or more of the features described herein, or as an alternative, further embodiments may include that the outlet of the inlet flow conditioner is connected to the inlet of the heat exchanger core, and the cross-sectional area of the outlet of the inlet flow conditioner is about equal to the cross-sectional area of the inlet of the heat exchanger core.

In addition to one or more of the features described herein, or as an alternative, further embodiments may include that the inlet of the inlet flow conditioner is connected to the outlet of the inlet pipe, and the cross-sectional area of the inlet of the inlet flow conditioner is about equal to the cross-sectional area of the outlet of the inlet pipe.

In addition to one or more of the features described herein, or as an alternative, further embodiments may include that at least one of the nose cone extends beyond the inlet of the inlet flow conditioner and the tail cone extends beyond the outlet of the inlet flow conditioner.

According to another embodiment, a method of delivering airflow to a heat exchanger core of a gas turbine engine is provided. The method including: imparting a rotational swirl upon airflow to a core of a heat exchanger; flowing the airflow through the heat exchanger core; and extracting heat from the airflow in the heat exchanger core.

In addition to one or more of the features described herein, or as an alternative, further embodiments may include that the rotation swirl is imparted by an inlet flow conditioner including: a central attachment body; an outer shell located radially outward from the central attachment body and the outer shell including an inlet, an outlet opposite the inlet; and a plurality of guide vanes extending from the central attachment body to the outer shell, the plurality of guide vanes being configured to impart a swirl upon airflow to the inlet and exiting the outlet.

According to an embodiment, a heat exchanger for a gas turbine engine is provided. The heat exchanger including: a heat exchanger core having an inlet, an outlet, and a fluid passageway fluidly connecting the inlet to the outlet, the fluid passageway is in thermal communication with a second passageway with a cooling fluid; an inlet pipe having an outlet fluidly connected to the inlet of the heat exchanger core, the inlet pipe configured to provide hot airflow to the inlet of the heat exchanger core, the outlet of the inlet pipe having a cross-sectional area less than a cross-sectional area of the inlet of the heat exchanger core; and an inlet flow conditioner fluidly connecting the outlet of the inlet pipe to the inlet of the heat exchanger core, the inlet flow conditioner including: a central attachment body; an outer shell located radially outward from the central attachment body, the outer shell including an inlet connected to the outlet of the inlet pipe, and an outlet opposite the inlet and connected to the inlet of the heat exchanger core; and a means for imparting swirl upon airflow entering the inlet of the inlet flow conditioner and exiting the outlet of the inlet flow conditioner.

In addition to one or more of the features described herein, or as an alternative, further embodiments may include that the means for imparting swirl upon airflow entering the inlet of the inlet flow conditioner and exiting the outlet of the inlet flow conditioner further comprises: a plurality of guide vanes extending from the central attachment body to the outer shell, the plurality of guide vanes being configured to impart a swirl upon airflow entering the inlet of the inlet flow conditioner and exiting the outlet of the inlet flow conditioner.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

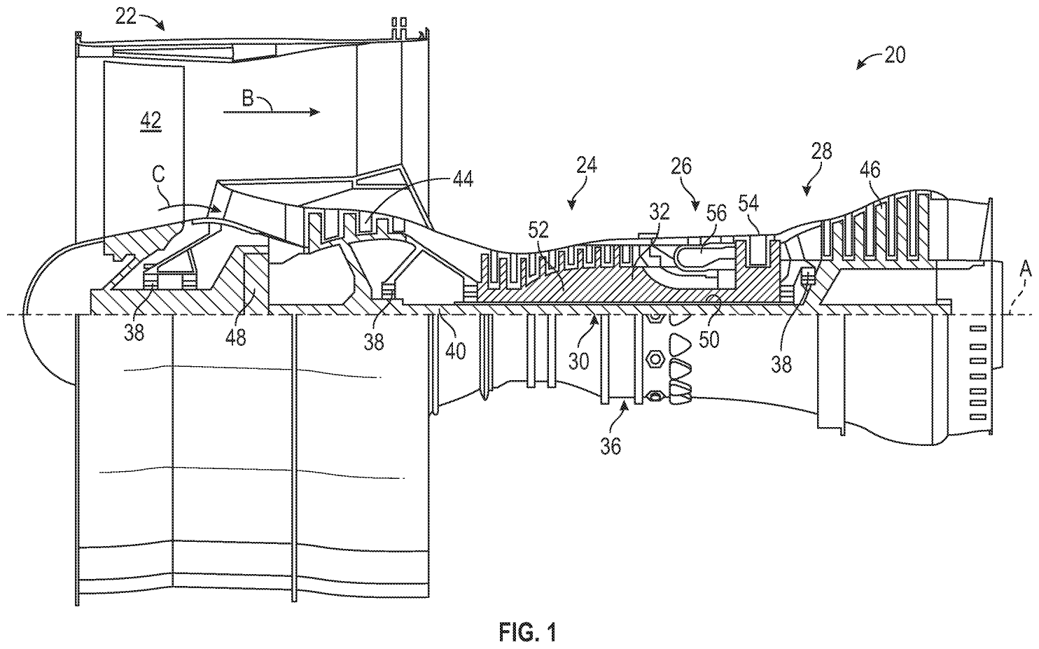

FIG. 1 is a partial cross-sectional illustration of a gas turbine engine, in accordance with an embodiment of the disclosure;

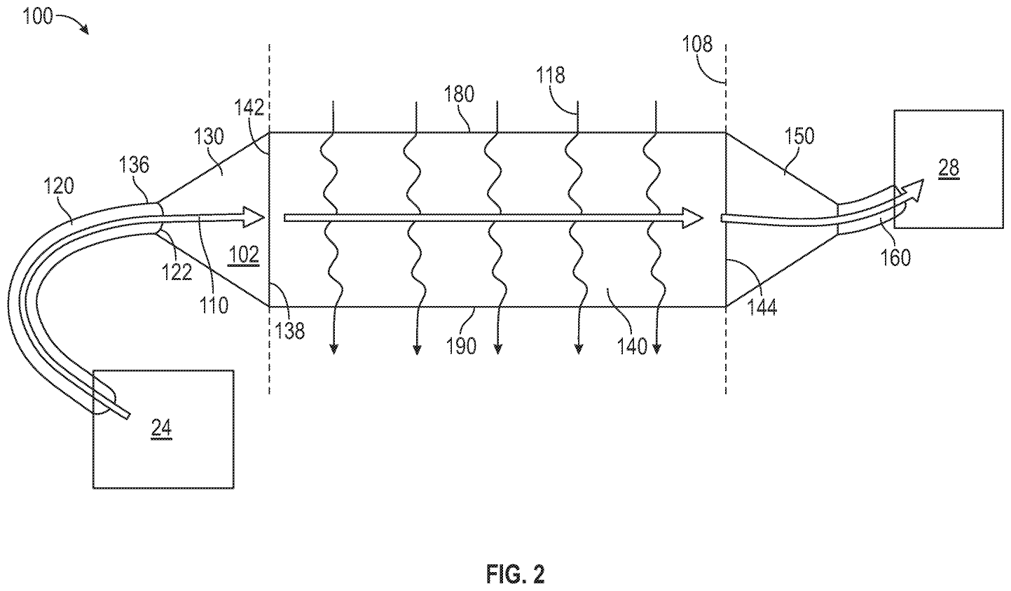

FIG. 2 is a cross-sectional illustration of a heat exchanger for use in the gas turbine engine of FIG. 1, in accordance with an embodiment of the disclosure;

FIG. 3 is a cross-sectional illustration of an inlet manifold of the heat exchanger of FIG. 2, in accordance with an embodiment of the disclosure;

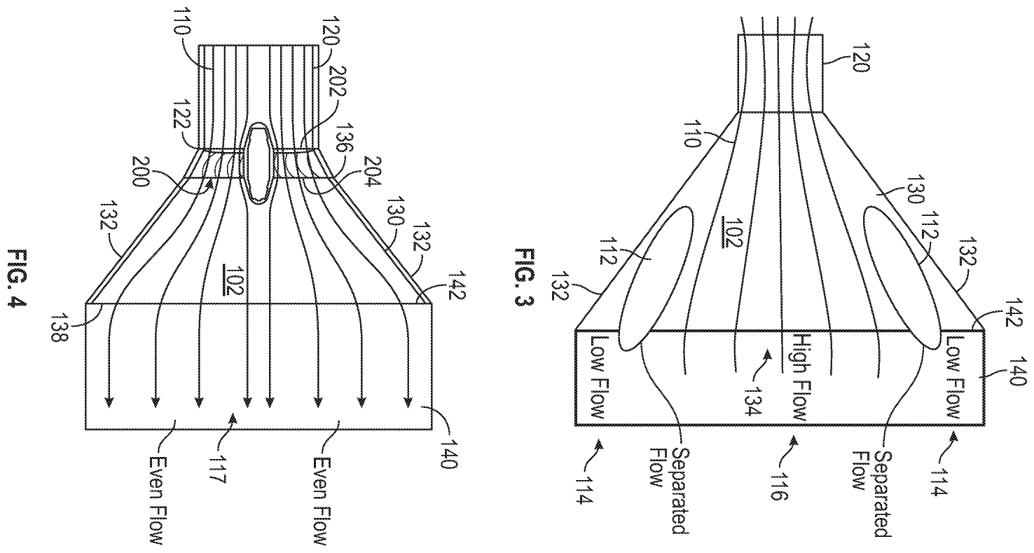

FIG. 4 is a cross-sectional illustration of an inlet flow conditioner and an inlet manifold of the heat exchanger of FIG. 2, in accordance with an embodiment of the disclosure;

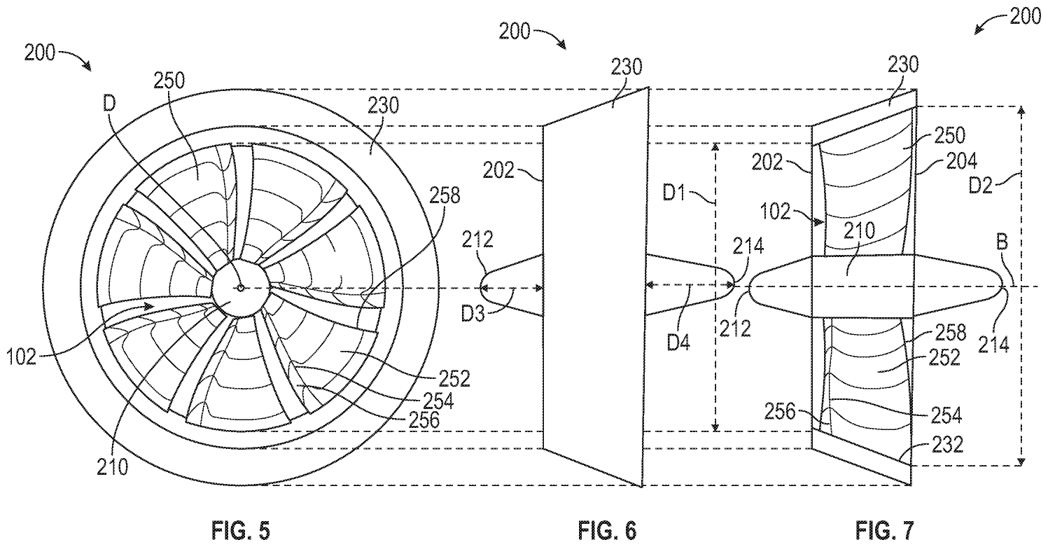

FIG. 5 is a frontal view of the inlet flow conditioner of FIG. 4, in accordance with an embodiment of the disclosure;

FIG. 6 is a side view of the inlet flow conditioner of FIG. 4, in accordance with an embodiment of the disclosure;

FIG. 7 is a cross-sectional side view of the inlet flow conditioner of FIG. 4, in accordance with an embodiment of the disclosure; and

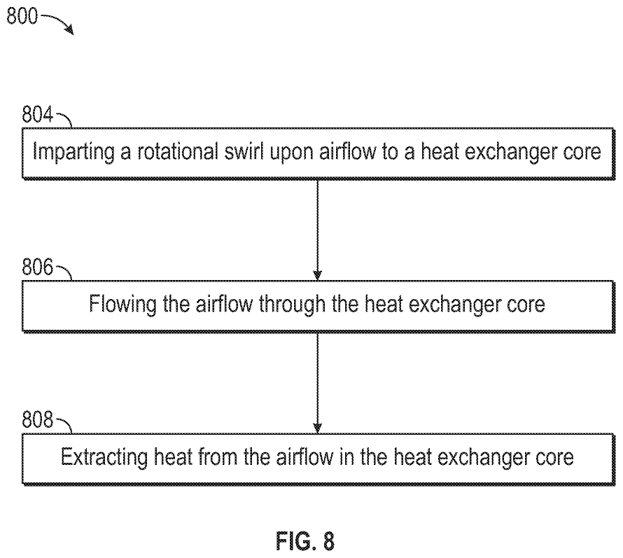

FIG. 8 is an illustration of a method of delivering airflow to a heat exchanger core of the heat exchanger of FIG. 2, in accordance with an embodiment of the disclosure.

The detailed description explains embodiments of the present disclosure, together with advantages and features, by way of example with reference to the drawings.

### DETAILED DESCRIPTION

A detailed description of one or more embodiments of the disclosed apparatus and method are presented herein by way of exemplification and not limitation with reference to the Figures.

The heat exchangers for aircraft are often constrained in terms of size. The heat exchanger must fit on the gas turbine engine, and the gas turbine engine must fit in the aircraft to a pre-defined size. Larger heat exchangers (longer, wider, and taller) result in more area for heat transfer, resulting in a lower outlet temperature of the air exiting the heat exchanger. The temperature of the air exiting the heat exchanger must be a certain, reduced, temperature in order for the cooled parts to meet life requirements. Airflow enters the heat-exchanger via an inlet manifold that expands the flow to feed into the large heat exchanger. If space was not limited within the aircraft, the inlet manifold would be optimized and lengthened to ‘gracefully’ expand the flow. However, due to the limited space within the aircraft, the inlet manifold must rapidly expand the flow, which results in separated flow along walls of the inlet manifold. The separated flow regions (e.g., near the walls of the heat exchanger) feed little flow into the heat exchanger and the non-separated region (e.g., near the center of the heat exchanger) feeds much more flow into the heat exchanger, thus resulting in an uneven spread of airflow as the air enters the heat exchanger. This an uneven spread of airflow results in a less effective heat exchanger and the air flow leaving the heat exchanger is warmer and at lower pressure than in a design with a larger, optimized, inlet manifold. Embodiment disclosed herein seek to optimize the airflow to the heat exchanger.

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

Referring now to FIG. 2, with continued reference to FIG. 1. FIG. 2 illustrates a heat exchanger 100 for use in the gas turbine engine 20 of FIG. 1. Air flow 110 from the compressor section 24 is directed to heat exchanger 100 through an inlet pipe 120 that fluidly connects the compressor section 24 to an inlet manifold 130 of the heat exchanger 130. The hot airflow 110 coming from the compressor section 24 may be hot due to the high operating temperature of the compressor section 24. The inlet manifold 130 increases a cross-sectional area of the fluid passageway 102 of the hot airflow 110 and expands the hot airflow 110 to feed into the heat exchanger core 140. The inlet manifold 130 includes an inlet 136 and an outlet 138. The outlet 138 has a cross-sectional area larger than the cross sectional area of the inlet 136, thus causing the hot airflow 110 to expand through the inlet manifold 130.

The heat exchanger core 140 is a non-mixing core, thus cooling air 118 in a second passageway 108 is physically separated from the hot airflow 110 in the heat exchanger core 140 but the hot airflow 110 is in thermal communication with the cooling air 118 of the second passageway 108, thus the cooling air 118 may absorb heat from the hot airflow 110 as the hot airflow 110 flows through fluid passageway 102 of the heat exchanger core 140 from the inlet 142 to an outlet 144. The cooling air 118 may be air from a bypass flow B or external to the gas turbine engine 20. The second passageway 108 may also utilize another cooling fluid other than cooling air 118. As mentioned above, the cooling air 118 is in a second fluid passageway 108 that is physically separate from the hot airflow 110. The cooling air 118 enters the heat exchanger core 140 at a cold flow inlet 180 and exits the heat exchanger core 140 at a cold flow outlet 190. Once the hot airflow 110 flows through the heat exchanger core 140 and exits the heat exchanger core 140, the hot airflow 110 enters an outlet manifold 150. The outlet manifold 150 decreases a cross-sectional area of the fluid passageway 102 of the hot airflow 110 to transfer the hot airflow 110 to an outlet pipe 160. The outlet pipe 160 fluidly connects the outlet manifold 150 to the turbine section 28.

Referring now to FIG. 3, with continued reference to FIGS. 1-2. FIG. 3 illustrates an inlet manifold 130 of the heat exchanger 100 of FIG. 2. The hot airflow 110 from the inlet pipe 120 enters the heat-exchanger 100 via the inlet manifold 130. To increase the heat transfer between the hot airflow 110 and the cool airflow 118 within the heat exchanger core 140 of the heat exchanger 100, the heat exchanger core 140 is typically larger in comparison to the inlet pipe 120. Since the inlet manifold 130 fluidly connects the inlet pipe 120 with a smaller fluid passageway 102 to the heat exchanger core 140 with a larger fluid passageway 102 the inlet manifold 130 is required to expand the hot airflow 110 to feed into the heat exchanger core 140. If space was not limited within the aircraft, the inlet manifold 130 would be optimized and lengthened to ‘gracefully’ expand the flow. However, due to the limited space within the aircraft, the inlet manifold 130 must rapidly expand the hot airflow 110, which results in separated flow 112 along the outer walls 132 of the inlet manifold 130. The separated flow regions 112 creates an area of reduced or low flow 114 into the heat exchanger core 140 and the non-separated region (e.g., near the center 134 of the fluid passageway 102) creates an area of high flow 116 into the heat exchanger core 140, thus resulting in an uneven spread of hot airflow 140 as the air enters the heat exchanger core 140. This an uneven spread of airflow results in a less effective heat transfer through the heat exchanger core 140 and the hot airflow 110 exiting the heat exchanger core 140 of the heat exchanger 140 is warmer and lower in pressure than in a design with a larger, optimized, inlet manifold.

Referring now to FIG. 4, with continued reference to FIGS. 1-3. FIG. 4 illustrates an inlet flow conditioner 200 for the inlet manifold 130 of the heat exchanger 100 of FIG. 2. As shown in FIG. 4, the inlet flow conditioner 200 is interposed between the inlet pipe 120 and the inlet manifold 130 and fluidly connects the inlet manifold 130 to the inlet pipe 120. The inlet flow conditioner 200 is configured to impart a swirl upon the hot airflow 110 passing through the inlet flow conditioner 200. The swirl imparted by the inlet flow conditioner 200 forces the hot airflow 110 to the outer walls 132 of the inlet manifold 130 due to centrifugal force, thus filling in the areas where separate flow 112 previously existed. Advantageously, the swirl imparted on the hot airflow 110 by the inlet flow conditioner 200 allows the hot airflow 110 to expand faster and across a shorter distance than without the inlet flow conditioner 200 and thus creates an even flow 117 of across the fluid passageway 102 within the heat exchanger core 140.

As shown in FIG. 4, the inlet 202 is connected to an outlet 122 of the inlet pipe 120 and the outlet 204 is connected to the inlet 142 of the heat exchanger core 140. The inlet manifold 130 fluidly connects the inlet flow conditioner 200 to the inlet 142 of the heat exchanger core 140. The inlet manifold 130 also includes an inlet 136 connected to the outlet 204 of the inlet flow conditioner 200 and an outlet 138 connected to the inlet 142 of the heat exchanger core 140. The outlet 138 of the inlet manifold 130 has a cross-sectional area larger than a cross-sectional area of the inlet 136 of the inlet manifold 130. The cross-sectional area of the outlet 138 of the inlet manifold 130 is about equal to the cross-sectional area of the inlet 142 of the heat exchanger core 140. The outlet 204 of the inlet flow conditioner 200 has a cross-sectional area larger than a cross-sectional area of the inlet 202 of the inlet flow conditioner 200. The cross-sectional area of the outlet 204 of the inlet flow conditioner 200 is about equal to the cross-sectional area of the inlet 136 of the inlet manifold 130. The cross-sectional area of the inlet 202 of the inlet flow conditioner 200 is about equal to the cross-sectional area of the outlet 122 of the inlet pipe 120.

In an embodiment, the outlet 204 of the inlet flow conditioner 200 may connected directly to the inlet 142 of the heat exchanger core 140, thus removing the inlet manifold 130 from the heat exchanger 100. In the embodiment without the inlet manifold 130, the outlet 204 of the inlet flow conditioner 200 is connected to the inlet 142 of the heat exchanger core 140 and the inlet 202 of the inlet flow conditioner 200 is connected to the outlet 122 of the inlet pipe 120. In the embodiment without the inlet manifold 130, the cross-sectional area of the outlet 204 of the inlet flow conditioner 200 is about equal to the cross-sectional area of the inlet 142 of the heat exchanger core 140. In the embodiment without the inlet manifold 130, the cross-sectional area of the inlet 202 of the inlet flow conditioner 200 is about equal to the cross-sectional area of the outlet 122 of the inlet pipe 120.

Referring now to FIGS. 5-7, with continued reference to FIGS. 1-4. FIG. 5 illustrates a frontal view (i.e., looking from the inlet pipe 120 towards the inlet flow conditioner 200) of the inlet flow conditioner 200 of FIG. 4. FIG. 5 illustrates a side view of the inlet flow conditioner 200 of FIG. 4 and FIG. 6 illustrates a cross-sectional side view of the inlet flow conditioner 200 of FIG. 4.

As shown in FIG. 5, the inlet flow conditioner 200 includes a plurality of guide vanes 250 extending from a central attachment body 210 to an outer shell 230. The central attachment body 210 is positioned at the central axis D of the inlet flow conditioner 200 and the outer shell 230 is located radially outward from the central attachment body 210. As shown in FIG. 5, the plurality of guide vanes 250 are positioned circumferentially around the central attachment body 210. The plurality of guide vanes 250 may be spaced equidistantly around the central attachment body 210. Each of the plurality of guide vanes 250 includes a pressure side 252, a leading edge 254, a suction side 256, and a trailing edge 258. The plurality of guide vanes 250 are stationary and do not rotate relative to the central attachment body 210. Characteristics of the guide vanes 250 may be further optimized through CFD analysis to provide a flow field into the inlet manifold that does not create separated flow areas 112 and provides even flow into the non-mixing core 140 of the heat exchanger 100. Characteristics of the guide vanes 250 may include but are not limited to airfoil, camber, twist, chord length, inlet/outlet angles, stagger angle, incidence angle, profile, thickness, and swirl direction.

The central attachment body 210 includes a nose cone 212 proximate an inlet 202 of the inlet flow conditioner 200 and a tail cone 214 proximate the outlet 204 of the inlet flow conditioner 200. The central attachment body 210 serves a structural point of connection for the plurality of guide vanes 250. The nose cone 210 is configured to direct hot airflow 110 entering the inlet 202 of the inlet flow conditioner 200 around the central attachment body 210. The nose cone 212 is configured to direct the hot airflow 110 around the central attachment body 210, such that frontal area drag of the central attachment body 210 is reduced. The tail cone 214 is configured to direct hot airflow 110 exiting the outlet 204 of the inlet flow conditioner 200 around the central attachment body 210. The tail cone 214 is configured to direct the hot airflow 110 around the central attachment body 210 proximate the outlet 204, such that trailing drag of the central attachment body 210 is reduced. In an embodiment, at least one of the nose cone 212 extends beyond the inlet 202 of the inlet flow conditioner 200 and the tail cone 214 extends beyond the outlet 204 of the inlet flow conditioner 200. For example, the nose cone 212 may extend beyond the inlet 202 of the inlet flow conditioner 200 by a selected distance D3 and/or the tail cone 214 may extend beyond the outlet 204 of the inlet flow conditioner 200 by a selected distance D4.

A shown in FIGS. 6 and 7, the outer shell 230 may have a conical frustum shape with a central fluid passageway 102. In another embodiment, the outer shell 230 may be contoured in shape, such that the outer shell 230 does not extend linearly from the inlet 202 to the outlet 204. For example, the outer shell 230 may extend curvilinearly from the inlet 202 to the outlet 204. The inlet flow conditioner 200 includes an inner surface 232 defining the fluid passageway 102 within the inlet flow conditioner 200. An inner radius D1 of the inner surface 232 at the inlet 202 is smaller than an inner radius D2 of the inner surface 232 at the outlet 204, thus the cross-sectional area of the fluid passageway 102 within the inlet flow conditioner 200 increases between the inlet 202 and the outlet 204. Advantageously, the increasing cross-section area of the fluid passageway between the inlet 202 and the outlet 204 also helps expand the hot airflow 110.

Referring now to FIG. 8, with continued reference to FIGS. 1-7. FIG. 8 illustrates a method 800 of delivering airflow 110 to a heat exchanger core 140 of a gas turbine engine 20. At block 804, a rotational swirl is imparted upon airflow 110 to heat exchanger core 140. In an embodiment, the rotational swirl may be imparted upon the airflow 110 prior to entering the heat exchanger core 140. The flow may be imparted by the inlet flow conditioner 200, as described above. The method 800 may further include expanding the airflow 110 to the heat exchanger core. In an embodiment, the airflow 110 is expanded after the rotational swirl is imparted on the airflow 100. The airflow 110 may be expanded by the inlet manifold 130. At block 806, the airflow 110 is flowed through the heat exchanger core 140. At block 808, heat is extracted from the airflow 110 in the heat exchanger core 140.

Technical effects of embodiments of the present disclosure include imparting a rotation swirl upon airflow to a heat exchanger core to increase thermal communication between the airflow and the heat exchanger core.

The term “about” is intended to include the degree of error associated with measurement of the particular quantity based upon the equipment available at the time of filing the application. For example, “about” can include a non-limiting range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A heat exchanger for a gas turbine engine, the heat exchanger comprising:
a heat exchanger core having an inlet, an outlet, and a fluid passageway fluidly connecting the inlet to the outlet, wherein the fluid passageway is in thermal communication with a second passageway with a cooling fluid;
an inlet pipe having an outlet fluidly connected to the inlet of the heat exchanger core, the inlet pipe configured to provide hot airflow to the inlet of the heat exchanger core, the outlet of the inlet pipe having a cross-sectional area less than a cross-sectional area of the inlet of the heat exchanger core; and
an inlet flow conditioner fluidly connecting the outlet of the inlet pipe to the inlet of the heat exchanger core, the inlet flow conditioner comprising:
a central attachment body;
an outer shell located radially outward from the central attachment body, the outer shell comprising an inlet connected to the outlet of the inlet pipe, and an outlet opposite the inlet and connected to the inlet of the heat exchanger core; and
a plurality of guide vanes extending from the central attachment body to the outer shell, the plurality of guide vanes being configured to impart a swirl upon airflow entering the inlet of the inlet flow conditioner and exiting the outlet of the inlet flow conditioner.

2. The heat exchanger of claim 1, further comprising:
an inlet manifold fluidly connecting the inlet flow conditioner to the heat exchanger core, the inlet manifold comprising an inlet connected to the outlet of the inlet flow conditioner and an outlet connected to the inlet of the heat exchanger core.

3. The heat exchanger of claim 2, wherein the outlet of the inlet manifold has a cross-sectional area larger than a cross-sectional area of the inlet of the inlet manifold.

4. The heat exchanger of claim 3, wherein the cross-sectional area of the outlet of the inlet manifold is about equal to the cross-sectional area of the inlet of the heat exchanger core.

5. The heat exchanger of claim 4, wherein the outlet of the inlet flow conditioner has a cross-sectional area larger than a cross-sectional area of the inlet of the inlet flow conditioner.

6. The heat exchanger of claim 5, wherein the cross-sectional area of the outlet of the inlet flow conditioner is about equal to the cross-sectional area of the inlet of the inlet manifold.

7. The heat exchanger of claim 5, wherein the cross-sectional area of the inlet of the inlet flow conditioner is about equal to the cross-sectional area of the outlet of the inlet pipe.

8. The heat exchanger of claim 1, wherein the central attachment body further comprises a nose cone proximate the inlet of the inlet flow conditioner, the nose cone being configured to direct hot airflow entering the inlet of the inlet flow conditioner around the central attachment body.

9. The heat exchanger of claim 1, wherein the central attachment body further comprises a tail cone proximate the outlet of the inlet flow conditioner, the tail cone being configured to direct hot airflow exiting the outlet of the inlet flow conditioner around the central attachment body.

10. The heat exchanger of claim 8, wherein the central attachment body further comprises a tail cone proximate the outlet of the inlet flow conditioner, the tail cone being configured to direct hot airflow exiting the outlet of the inlet flow conditioner around the central attachment body.

11. The heat exchanger of claim 1, wherein the outer shell is conical frustum in shape.

12. The heat exchanger of claim 1, wherein the outer shell is contoured in shape.

13. The heat exchanger of claim 1, wherein the outlet of the inlet flow conditioner has a cross-sectional area larger than a cross-sectional area of the inlet flow conditioner.

14. The heat exchanger of claim 13, wherein the outlet of the inlet flow conditioner is connected to the inlet of the heat exchanger core, and wherein the cross-sectional area of the outlet of the inlet flow conditioner is about equal to the cross-sectional area of the inlet of the heat exchanger core.

15. The heat exchanger of claim 13, wherein the inlet of the inlet flow conditioner is connected to the outlet of the inlet pipe, and wherein the cross-sectional area of the inlet of the inlet flow conditioner is about equal to the cross-sectional area of the outlet of the inlet pipe.

16. The heat exchanger of claim 10, wherein at least one of the nose cone extends beyond the inlet of the inlet flow conditioner and the tail cone extends beyond the outlet of the inlet flow conditioner.

17. A method of delivering airflow to a heat exchanger core of a gas turbine engine, the method comprising:
imparting a rotational swirl upon airflow to a core of a heat exchanger;
flowing the airflow through the heat exchanger core; and
extracting heat from the airflow in the heat exchanger core.

18. The method of claim 17, wherein the rotation swirl is imparted by an inlet flow conditioner comprising:
a central attachment body;
an outer shell located radially outward from the central attachment body and the outer shell comprising an inlet, an outlet opposite the inlet; and
a plurality of guide vanes extending from the central attachment body to the outer shell, the plurality of guide vanes being configured to impart a swirl upon airflow to the inlet and exiting the outlet.

19. A heat exchanger for a gas turbine engine, the heat exchanger comprising:
a heat exchanger core having an inlet, an outlet, and a fluid passageway fluidly connecting the inlet to the outlet, wherein the fluid passageway is in thermal communication with a second passageway with a cooling fluid;
an inlet pipe having an outlet fluidly connected to the inlet of the heat exchanger core, the inlet pipe configured to provide hot airflow to the inlet of the heat exchanger core, the outlet of the inlet pipe having a cross-sectional area less than a cross-sectional area of the inlet of the heat exchanger core; and
an inlet flow conditioner fluidly connecting the outlet of the inlet pipe to the inlet of the heat exchanger core, the inlet flow conditioner comprising:
a central attachment body;
an outer shell located radially outward from the central attachment body, the outer shell comprising an inlet connected to the outlet of the inlet pipe, and an outlet opposite the inlet and connected to the inlet of the heat exchanger core; and
a means for imparting swirl upon airflow entering the inlet of the inlet flow conditioner and exiting the outlet of the inlet flow conditioner.

20. The heat exchanger of claim 19, where the means for imparting swirl upon airflow entering the inlet of the inlet flow conditioner and exiting the outlet of the inlet flow conditioner further comprises:
a plurality of guide vanes extending from the central attachment body
to the outer shell, the plurality of guide vanes being configured to impart a swirl upon airflow entering the inlet of the inlet flow conditioner and exiting the outlet of the inlet flow conditioner.
